(19) United States
(12) Patent Application Publication
(10) Pub. No.: US 2015/0043556 A1
(43) Pub. Date: Feb. 12, 2015

(54) Enabling Communication Between Wireless Devices

(71) Applicants: Bin Xu, The Woodlands, TX (US); Vasudev Rayachoti, The Woodlands, TX (US)

(72) Inventors: Bin Xu, The Woodlands, TX (US); Vasudev Rayachoti, The Woodlands, TX (US)

(21) Appl. No.: 14/336,605

(22) Filed: Jul. 21, 2014

Related U.S. Application Data
(60) Provisional application No. 61/863,374, filed on Aug. 7, 2013.

(51) Int. Cl. H04W 88/16; H04L 29/08

(52) U.S. Cl. CPC H04W 88/16; H04L 67/12; H04W 84/12
USPC 370/338

(57) ABSTRACT

A hybrid wireless network, method, and plant for enabling communication between wireless devices are provided herein. An exemplary embodiment provides a hybrid wireless network for enabling communication between wireless devices. The hybrid wireless network includes a gateway that is enabled with a wireless sensor network protocol and a Wi-Fi protocol, wherein the hybrid sensor network enables communication between a wireless handheld device and a plurality of wireless transmitters using the wireless sensor network protocol and the Wi-Fi protocol. The wireless handheld device and at least a portion of the plurality of wireless transmitters are enabled with the wireless sensor network protocol and the Wi-Fi protocol.

### CROSS REFERENCE TO RELATED APPLICATIONS

This application claims the priority benefit of U.S. Patent Application 61/863,374 filed Aug. 7, 2013 entitled ENABLING COMMUNICATION BETWEEN WIRELESS DEVICES, the entirety of which is incorporated by reference herein.

### FIELD OF THE INVENTION

The present techniques enable communication between wireless devices using a hybrid wireless network. More specifically, the present techniques enable communication between wireless devices and wireless transmitters that utilize different network protocols using a hybrid wireless network that supports both network protocols.

### BACKGROUND

This section is intended to introduce various aspects of the art, which may be associated with exemplary embodiments of the present techniques. This discussion is believed to assist in providing a framework to facilitate a better understanding of particular aspects of the present techniques. Accordingly, it should be understood that this section should be read in this light, and not necessarily as admissions of prior art.

Wireless transmitters are often used in the oil and gas industry to collect process data relating to components of a system, such as process data corresponding to the pressure, temperature, level, flow and valve position of such components. Such process data are often utilized by wireless handheld devices to conduct maintenance and operation activities. In addition, such process data may be sent from wireless handheld devices to a distributed control system (DCS) or an asset management system, for example. Specifically, the data may be uploaded to the DCS or the asset management system in real-time online via a Wi-Fi network, or may be downloaded offline via a memory unit.

However, wireless transmitters and wireless handheld devices utilize different communication protocols. Specifically, wireless transmitters utilize wireless sensor network protocols, such as WirelessHART ISA100.11a or any other type of standard or proprietary sensor network protocol, while wireless handheld devices generally utilize Wi-Fi protocol. Moreover, the network infrastructure used by Wi-Fi protocol differs from the network infrastructure used by wireless sensor network protocol. Due to this incompatibility, wireless handheld devices are typically not able to communicate directly with wireless transmitters.

### SUMMARY

An exemplary embodiment provides a hybrid wireless network for enabling communication between wireless devices. The hybrid wireless network includes a gateway that is enabled with a wireless sensor network protocol and a Wi-Fi protocol, wherein the hybrid sensor network enables communication between a wireless handheld device and a plurality of wireless transmitters using the wireless sensor network protocol and the Wi-Fi protocol. The wireless handheld device and at least a portion of the plurality of wireless transmitters are enabled with the wireless sensor network protocol and the Wi-Fi protocol.

Another exemplary embodiment provides a method for communicating with a wireless transmitter via a hybrid wireless network. The method includes establishing, at a wireless handheld device, a wireless sensor network connection with a plurality of wireless transmitters via a hybrid wireless network using a wireless sensor network protocol. A Wi-Fi network connection is established at the wireless handheld device with at least a portion of the plurality of wireless transmitters via the hybrid wireless network using a Wi-Fi protocol. Any of the plurality of wireless transmitters can be communicated with the wireless handheld device via the wireless sensor network connection. The wireless handheld device can communicate with any of the portion of the plurality of wireless transmitters via the Wi-Fi network connection.

Another exemplary embodiment provides a plant that includes a plurality of plant components. The plant includes a hybrid wireless network including a wireless sensor network that uses a wireless sensor network protocol and a Wi-Fi network that uses a Wi-Fi protocol. A wireless handheld device is enabled to use the wireless sensor network protocol and the Wi-Fi protocol. Wireless transmitters are included, wherein a first portion of the wireless transmitters are only enabled to use the wireless sensor network protocol and a second portion of the wireless transmitters are enabled to use the wireless sensor network protocol and the Wi-Fi protocol. The wireless transmitters are configured to collect process data corresponding to any of the plurality of plant components and send the process data to the wireless handheld device.

### BRIEF DESCRIPTION OF THE DRAWINGS

The advantages of the present techniques are better understood by referring to the following detailed description and the attached drawings, in which:

FIG. 1 is a schematic of a hybrid wireless network that enables communication between a wireless handheld device and a number of wireless transmitters;

FIG. 2 is another schematic of the hybrid wireless network showing the manner in which the hybrid wireless network enables communication between the wireless handheld device and the wireless transmitters as the location of the wireless handheld device within the hybrid wireless network changes;

FIG. 3 is a block diagram of a wireless adapter coupled to a plant network device;

FIG. 4 is a block diagram showing three menus for performing various functions via a wireless handheld device;

FIG. 5 is a schematic of a system that may be used to perform equipment health monitoring, asset management, or data mining activities for a plant via a hybrid wireless network;

FIG. 6 is a process flow diagram of a method for communicating with a wireless device via a hybrid wireless network; and

FIG. 7 is a block diagram of a wireless handheld device that may communicate with a wireless transmitter or other wireless device via a hybrid wireless network.

### DETAILED DESCRIPTION

In the following detailed description section, specific embodiments of the present techniques are described. However, to the extent that the following description is specific to a particular embodiment or a particular use of the present techniques, this is intended to be for exemplary purposes only and simply provides a description of the exemplary embodiments. Accordingly, the techniques are not limited to the specific embodiments described below, but rather, include all alternatives, modifications, and equivalents falling within the true spirit and scope of the appended claims.

As discussed above, wireless transmitters utilize wireless sensor network protocols, while wireless handheld devices generally utilize Wi-Fi protocol. Moreover, the network infrastructure used by Wi-Fi protocol differs from the network infrastructure used by wireless sensor network protocols. Due to this incompatibility, wireless handheld devices are typically not able to communicate directly with wireless transmitters or utilize the infrastructure of wireless sensor networks.

Accordingly, embodiments described herein enable communication between a wireless handheld device and a wireless transmitter that utilize different network protocols, e.g., wireless sensor network protocol and Wi-Fi protocol, using a hybrid wireless network that supports both network protocols. The wireless handheld device may be enabled to transmit and receive data via both Wi-Fi protocol and wireless sensor network protocol. In addition, while most of the wireless transmitters within a particular system, e.g., a plant, are only enabled to transmit and receive data via wireless sensor network protocol, a portion of the wireless transmitters are enabled to transmit and receive data via both Wi-Fi protocol and wireless sensor network protocol. This may allow the portion of wireless transmitters to function as routers for sending high bandwidth data to and from the wireless handheld device via W-Fi protocol. Therefore, embodiments described herein allow a single hybrid wireless network system to be installed for both the wireless sensor network and the Wi-Fi network, instead of having to install separate wireless network systems. The wireless transmitters that are included within the hybrid wireless network act as not only sensors but also as routers that can route data to and from various wireless transmitters and wireless handheld devices.

In various embodiments, equipment health monitoring systems, asset management systems, or other data mining systems enable maintenance activities to be performed in order to diagnose potential failures of components within a system. According to current technology, all the key data is collected online and sent to a data storage device, such as a data historian. A software package then either processes the data on a real-time basis or post-processes the data to predict any potential failures of system components. In addition, real-time data from a wireless hand-held device is sometimes used for such maintenance activities when they are conducted on-site. However, current technology does not enable all the data to be directly accessed via the wireless handheld device. Further, in some cases, wireless transmitters are not available on-site, and the installation of new wireless transmitters may be cost prohibitive. Accordingly, embodiments described herein provide an on-site equipment health monitoring system in which key components are connected to radio-frequency identification (RFID) devices such that a wireless handheld device can identify the key components via the RFID devices. The process data obtained via particular components are typically collected via wireless transmitters installed around the components. According to embodiments described herein, the tag ID for a particular component is associated with an RFID device to allow a wireless handheld device to identify the process data corresponding to the component.

The wireless handheld device described herein includes several additional functions that are not included within current wireless handheld devices. Specifically, the wireless handheld device described herein can directly read data and send the data to a distributed control system (DCS), for example, via a wireless sensor network, such as WirelessHART or ISA100.11a. If the data to be sent to the DCS is only process data, such as data relating to the temperature or pressure of specific components, the wireless handheld device will send data to the DCS via the wireless sensor network. However, if the data to be sent to the DCS is any other type of data that requires higher bandwidth and more comprehensive data packets, such as video data, image data, or audio data, then the wireless handheld device will send the data to the DCS via the Wi-Fi network. In addition, the wireless handheld device can communicate with other high band-width, wireless-enabled equipment such as video cameras, audio systems, and the like. Further, the wireless handheld device described herein includes the basic functionalities of typical wireless handheld devices. For example, the wireless handheld device is capable of recording data, providing maintenance workflows, sending video data and audio data, and the like.

The wireless handheld device described herein can also be used to conduct preliminary data analyses relating to equipment health monitoring, asset management, and/or data mining. For example, the wireless handheld device can receive process data via RFID devices that are associated with the tag IDs of particular components within the system. The wireless handheld device may then send such data wirelessly to an equipment health monitoring system, asset management system, and/or data mining system.

The wireless transmitters that are enabled to transmit and receive data via both Wi-Fi protocol and wireless sensor network protocol can be used for several purposes. First, the wireless transmitters can be used as sensing elements to collect process data relating to components within a system, such as process data corresponding to the pressure, temperature, level, flow and valve position of such components. Second, the wireless transmitters can be used as routing devices for the wireless sensor network. Third, the wireless transmitters can be used as routing devices for the Wi-Fi network, allowing video data, image data, audio data, and the like to be sent over the Wi-Fi network.

In addition to above mentioned challenges, using sophisticated handheld device and wireless sensor network can be cost prohibitive for some certain applications. For example, in order to measure pressure or temperature along a pipeline to leakage of a pipeline, installing a large number of wireless transmitters can be extremely expensive. In a mature field where even wired transmitters are often not available, it may be cost prohibitive to install new transmitters since production may have to be shutdown for hot work. Some of these issues may be aided by the use of micro-electro mechanical systems (MEMS) technology which relies on the modulation of surface acoustic waves to sense a physical phenomenon.

A MEMS sensor can transform an input electrical signal into a mechanical wave which, unlike an electrical signal, can be easily influenced by physical phenomena. The device can then transduces this wave back into an electrical signal. Changes in amplitude, phase, frequency, or time-delay between the input and output electrical signals can be used to measure the presence of the desired phenomenon. MEMS sensors can be used to measure pressure, strain, temperature, mass, chemical vapors, humidity, viscosity and so on.

MEMS devices can be used with the network devices described herein, for example, in the applications of monitoring pipeline temperature, pressure, or leakage in combination with typical wireless transmitters. For example, a single wireless transmitter can be wirelessly connected to a number of MEMS sensors. The MEMS sensors can collect the information, measuring such parameters as pressure, temperature, chemical vapors and sending the data back to the wireless transmitter. The transmitter or handheld device can function as a hub and source of signal excitation for a number of MEMS sensors. MEMS sensors can communicate with handheld devices or transmitters via a radio built into the sensor. The handheld device or transmitter can then package the data and send it out over a wireless sensor network such as WirelessHART, ISA100.11a, or other open and proprietary protocols, such as an IEEE 802.11 (Wi-Fi) network.

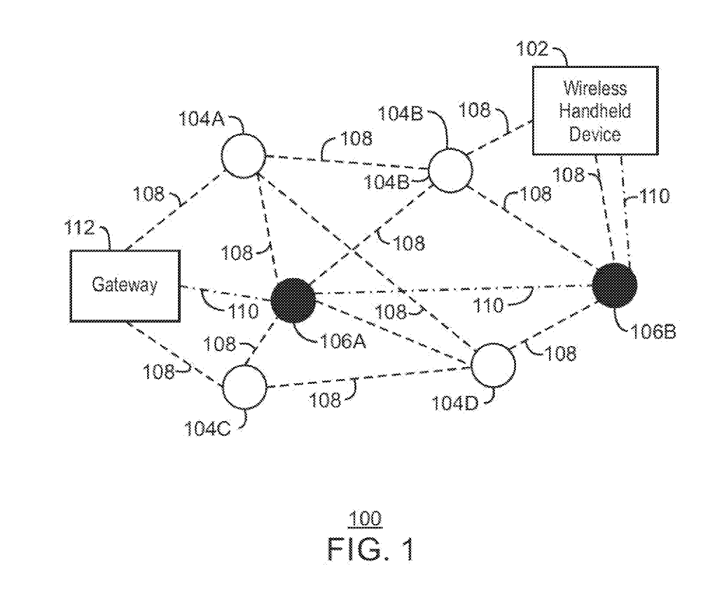

FIG. 1 is a schematic of a hybrid wireless network 100 that enables communication between a wireless handheld device 102 and a number of wireless transmitters 104A, 104B, 104C, 104D, 106A, and 106B. The hybrid wireless network 100 is a combination of a wireless sensor network and a Wi-Fi network. Therefore, the hybrid wireless network provides communication between wireless devices using wireless sensor network protocol, as indicated by lines 108, and/or Wi-Fi protocol, as indicated by lines 110. In some embodiments, the wireless sensor network protocol used by the wireless hybrid network 100 is WirelessHART or ISA100.11a.

As shown in FIG. 1, the hybrid wireless network 100 includes a gateway 112 that is enabled with both wireless sensor network protocol and Wi-Fi protocol. The wireless sensor network also includes the wireless handheld device 102, which is enabled with both wireless sensor network protocol and Wi-Fi protocol.

In addition, the wireless sensor network includes the wireless transmitters 104A, 104B, 104C, 104D, 106A, and 106B. Each wireless transmitter 104A, 104B, 104C, 104D, 106A, and 106B may function as both a sensing device that measures process variables and a routing device that routes wireless sensor network data. A majority of the wireless transmitters 104A, 104B, 104C, and 104D are only enabled with wireless sensor network protocol. However, several of the wireless transmitters 106A and 106B are enabled with both wireless sensor network protocol and Wi-Fi protocol.

The wireless transmitters 104A, 104B, 104C, 104D, 106A, and 106B may include wired sensors, such as Wirec type sensors, and purely wireless sensors. Further, the wireless transmitters 104A, 104B, 104C, 104D, 106A, and 106B may include purely wireless repeaters having no sensing capability. The wireless communications capability may be built into sensors during manufacture, or may be added to sensors, for example, in the field, using an attached wireless adaptor.

The locations of the wireless transmitters 106A and 106B that are enabled with both network protocols within the hybrid wireless network 100 are determined such that the range of the Wi-Fi network is maximized. The wireless transmitters 106A and 106B may function as Wi-Fi routers for the wireless handheld device 102 when the Wi-Fi signal directly from the gateway 112 is beyond the reach of the wireless handheld device 102.

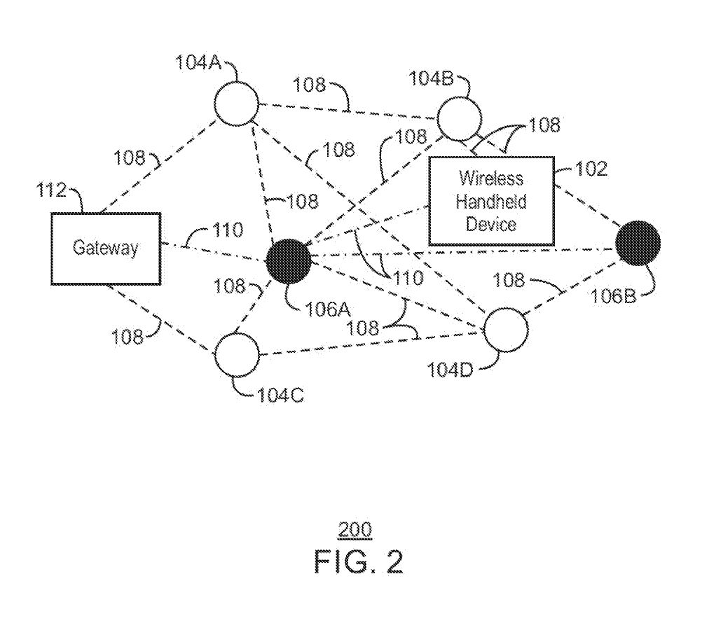

FIG. 2 is another schematic of the hybrid wireless network 100 showing the manner in which the hybrid wireless network 100 enables communication between the wireless handheld device 102 and the wireless transmitters 104A, 104B, 104C, 104D, 106A, and 106B as the location of the wireless handheld device 102 within the hybrid wireless network 100 changes. As shown in FIG. 2, when the wireless handheld device 102 moves from one location to another within the hybrid wireless network 100, the hybrid wireless network 100 is configured to automatically link the wireless handheld device 102 with both the wireless sensor network protocol and the Wi-Fi protocol. This may be accomplished by re-routing the wireless sensor network protocol and the Wi-Fi protocol via wireless transmitters that are in the vicinity of the wireless handheld device 102.

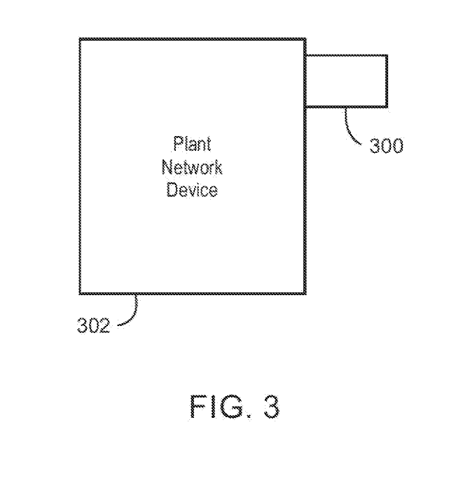

FIG. 3 is a block diagram of a wireless adapter 300 coupled to a plant network device 302. The plant network device 302 can include, for example, wireless transmitters 104A, 104B, 104C, 104D, 106A, and 106B as described with respect to FIGS. 1 and 2, and well as a wireless handheld device 102 used for communicating with sensors and the plant control system. According to embodiments described herein, the wireless handheld device 102 can directly read and send data via a hybrid wireless network. In some embodiments, the wireless handheld device 102 can communicate with wireless transmitters directly via the hybrid wireless network using a wireless sensor network protocol, such as WirelessHART or ISA100.11a. However, in some embodiments, a plant network device 302, such as a wireless handheld device 102, or a sensor, cannot communicate directly through the wireless sensor network protocol. In such embodiments, a wireless adapter 300 can be used to convert the protocol used by the plant network device 302, such as Wi-Fi protocol, to the wireless sensor network protocol. Then, the plant network device 302, such as the wireless handheld device 102, can receive data from wireless transmitters directly in the format of WirelessHART or ISA100.11a, for example. In addition, the wireless adapter 300 that is coupled to the plant network device 302 can serve as a routing device to enable other wireless devices that utilize the wireless sensor network protocol to join the hybrid wireless network.

In some embodiments, antennas are installed within wireless transmitters to extend the range of the hybrid wireless network. For example, if a wireless transmitter is enabled with both Wi-Fi protocol and wireless sensor network protocol, then a separate antenna may be installed within the wireless transmitter for each protocol.

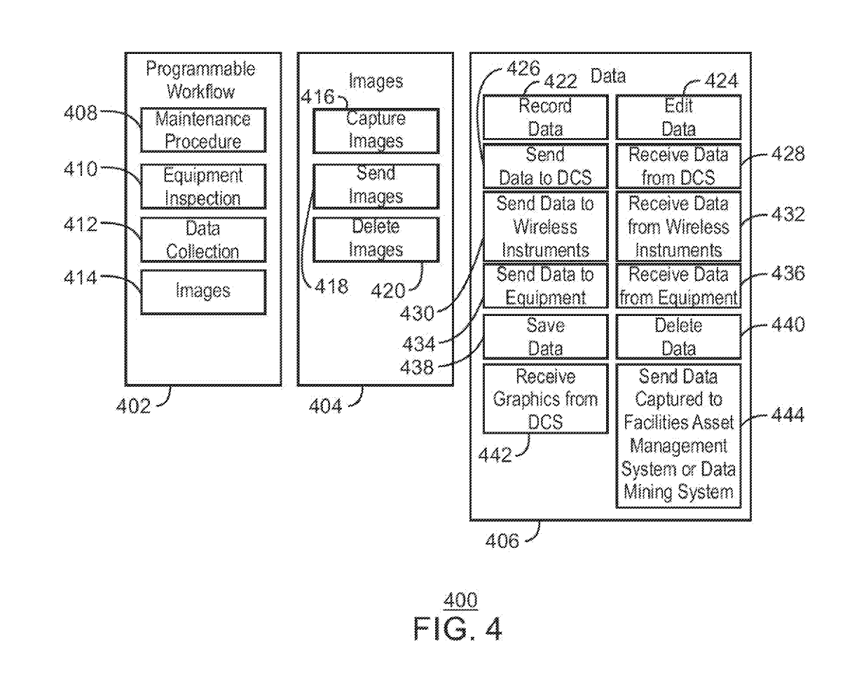

FIG. 4 is a block diagram showing three menus 402, 404, and 406 for performing various functions via a wireless handheld device. In addition to the features described herein with relation to the hybrid wireless network, the wireless handheld device described herein includes the basic functionalities of typical wireless handheld devices. For example, the wireless handheld device is capable of capturing and sending images, recording and sending data, configuring equipment settings, providing and recording maintenance procedures, and providing radio communications to a DCS.

As shown in FIG. 4, the wireless handheld device may include a programmable workflow menu 402, an images menu 404, and a data menu 406. Each menu may include several options relating to specific functionalities of the wireless handheld device. For example, the programmable workflow menu 402 may include a maintenance workflow option 408, an equipment inspection option 410, a data collection option 412, and an images option 414. The images menu 404 may include an option 416 for capturing images, an option 418 for sending images, and an option 420 for deleting images. In addition, the data menu 406 may include an option 422 for recording data, an option 424 for editing data, an option 426 for sending data to a DCS, an option 428 for receiving data from the DCS, and option 430 for sending data to wireless instruments, and an option 432 for receiving data from wireless instruments. Further, the data menu 406 may include an option 434 for sending data to equipment, an option 436 for receiving data from equipment, an option 438 for saving data, an option 440 for deleting data, an option 442 for receiving graphics from the DCS, and an option 444 for sending captured data to a facilities asset management system and/or a data mining system. Moreover, the wireless handheld device may also include any number of additional menus for performing various other functionalities.

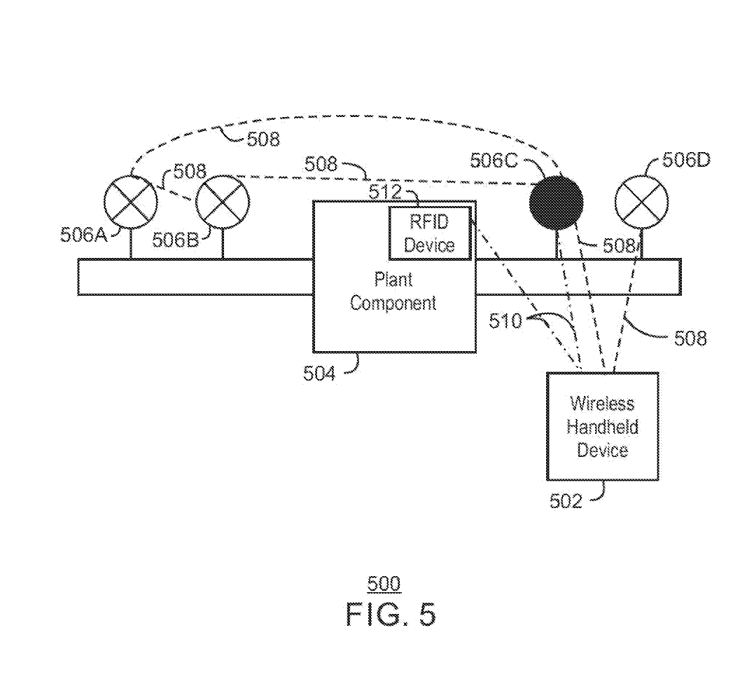

FIG. 5 is a schematic of a system 500 that may be used to perform equipment health monitoring, asset management, or data mining activities for a plant via a hybrid wireless network. The system 500 may include a wireless handheld device 502 and a number of plant components, such as plant component 504 shown in FIG. 5. In addition, the system 500 may include a number of wireless transmitters 506A, 506B, 506C, and 506D.

The system 500 may also include a hybrid wireless network that enables communication between the wireless handheld device 502, the wireless transmitters 506A-D, and the plant component 504. The hybrid wireless network may be a combination of a wireless sensor network and a Wi-Fi network. Therefore, the hybrid wireless network enables communication between the wireless devices using wireless sensor network protocol, as indicated by lines 508, and/or Wi-Fi protocol, as indicated by lines 510.

As shown in FIG. 5, the wireless handheld device 502 may be enabled with both wireless sensor network protocol and Wi-Fi protocol. In addition, while a majority of the wireless transmitters, e.g., the wireless transmitters 506A, 506B, and 506D, are only enabled with wireless sensor network protocol, at least a portion of the wireless transmitters, e.g., the wireless transmitter 506C, are enabled with both wireless sensor network protocol and Wi-Fi protocol. In various embodiments, each wireless transmitter 506A-D may function as both a sensing device that measures process variables and a routing device that routes wireless sensor network data. Further, the wireless transmitter 506C that is enabled with both network protocols may also function as a routing device that routes Wi-Fi data.

Each plant component, including the plant component 504 shown in FIG. 5, may be connected to an RFID device 512. The RFID device 512 may allow the wireless handheld device 502 to identify the plant component 504. In various embodiments, the process data of the plant component 504 is collected via the wireless transmitters 306A-D installed around the plant component 504. In some embodiments, a tag ID of the plant component 504 is associated with the RFID device 512 that is connected to the plant component 504 to allow the wireless handheld device 502 to identify the process data corresponding to the plant component 504. The process data may then be used to perform equipment health monitoring, asset management, and/or data mining activities. For example, the wireless handheld device 502 may conduct some preliminary data analysis activities, including equipment health monitoring, asset management and/or data mining activities, and send the resulting data wirelessly to a plant equipment health monitoring system, asset management system, and/or data mining system.

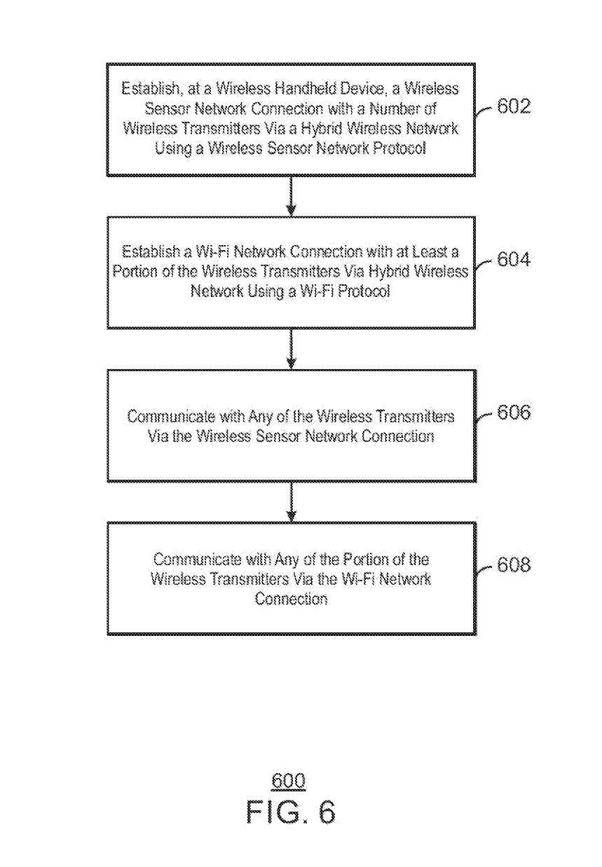

FIG. 6 is a process flow diagram of a method 600 for communicating with a wireless device via a hybrid wireless network. In various embodiments, the method 600 is implemented by a wireless handheld device, such as a mobile phone or tablet computing device. The method begins at block 602, at which the wireless handheld device establishes a wireless sensor network connection with a number of wireless transmitters via a hybrid wireless network using a wireless sensor network protocol. The wireless sensor network protocol may be WirelessHART or ISA100.11a, for example. At block 604, the wireless handheld device establishes a Wi-Fi network connection with at least a portion of the wireless transmitters via the hybrid wireless network using a Wi-Fi protocol.

At block 606, the wireless handheld device communicates with any of the wireless transmitters via the wireless sensor network connection. For example, the wireless handheld device may receive process data corresponding to plant components from any of the wireless transmitters via the wireless sensor network connection. The wireless handheld device may then send the process data to a distributed control system (DCS) or an asset management system, for example. In addition, the wireless handheld device may associate at least a portion of the process data with a particular plant component based on an RFID device connected to the particular plant component.

At block 608, the wireless handheld device communicates with any of the portion of the wireless transmitters via the Wi-Fi network connection. For example, the wireless handheld device may send data, such as image data, audio data, or video data, for example, to another wireless device via the Wi-Fi network connection by using one of the wireless transmitters as a Wi-Fi router.

The process flow diagram of FIG. 6 is not intended to indicate that the blocks of the method 600 are to be executed in any particular order, or that all of the blocks are to be included in the method 600 in every case. Further, any number of additional blocks not shown in FIG. 6 may be included within the method 600, depending on the details of the specific implementation.

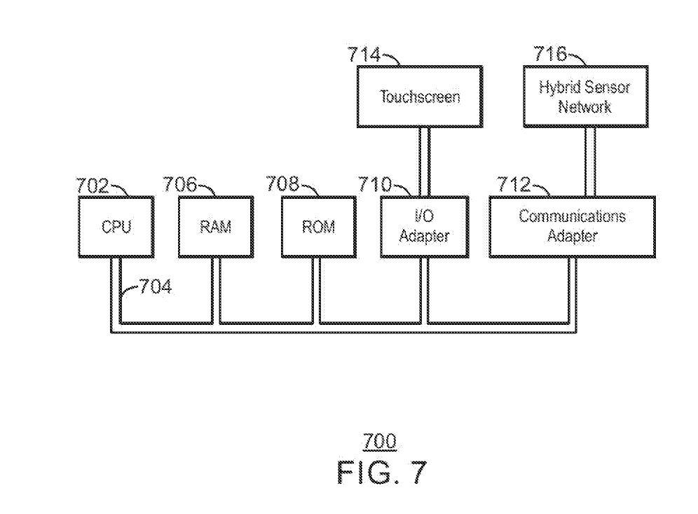

FIG. 7 is a block diagram of a wireless handheld device 700 that may communicate with a wireless transmitter or other wireless device via a hybrid wireless network. The wireless handheld device 700 may be any suitable type of wireless computing device, such as a mobile phone or tablet computer.

As shown in FIG. 7, the wireless handheld device 700 may include a central processing unit (CPU) 702 that is coupled to a system bus 704. The CPU 702 may be any general-purpose CPU, although other types of architectures of CPU may be used as long as the CPU 702 supports the embodiments described herein. The CPU 702 may execute various logical instructions according to the embodiments described herein. For example, the CPU 702 may execute machine-level instructions for communicating with a wireless transmitter or other wireless device via a hybrid wireless network.

The wireless handheld device 700 may include computer components such as a random access memory (RAM) 706, which may be SRAM, DRAM, SDRAM, or the like. The wireless handheld device 700 may also include read-only memory (ROM) 708, which may be PROM, EPROM, EEPROM, or the like. The RAM 706 and the ROM 708 within the wireless handheld device 700 may hold user and system data and programs. For example, the RAM 706 and the ROM 708 may hold measurement data relating to components within a system, such as measurement data corresponding to the pressure, temperature, level, flow and valve position of such components.

In addition, the wireless handheld device 700 may include an input/output (I/O) adapter 710 and a communications adapter 712. The I/O adapter 710 may connect the wireless handheld device 700 to any number of I/O devices, such as a touchscreen 714. The touchscreen 714 may enable a user to interact with the wireless handheld device 700 to input information, and may display information to the user.

According to embodiments described herein, the communications adapter 712 may couple the wireless handheld device 700 to a hybrid wireless network 716. The hybrid wireless network 716 may enable the wireless handheld device 700 to communicate with one or more wireless transmitters or other wireless devices using Wi-Fi protocol and/or wireless sensor network protocol.

The block diagram of FIG. 7 is not intended to indicate that the wireless handheld device 700 is to include all of the components shown in FIG. 7. Rather, any of the components shown in FIG. 7 may be modified or omitted, depending on the details of the specific implementation. Further, any number of additional components not shown in FIG. 7 may be included within the wireless handheld device 700, depending on the details of the specific implementation.

### Embodiments

Embodiments of the invention may include any combinations of the methods and systems shown in the following numbered paragraphs. This is not to be considered a complete listing of all possible embodiments, as any number of variations can be envisioned from the description above.

1. A hybrid wireless network for enabling communication between wireless devices, including a gateway that is enabled with a wireless sensor network protocol and a Wi-Fi protocol, wherein the hybrid sensor network enables communication between a wireless handheld device and a plurality of wireless transmitters using the wireless sensor network protocol and the Wi-Fi protocol, and wherein the wireless handheld device and at least a portion of the plurality of wireless transmitters are enabled with the wireless sensor network protocol and the Wi-Fi protocol.

2. The hybrid wireless network of paragraph 1, wherein the plurality of wireless transmitters are configured to:

collect process data corresponding to a plurality of plant components; and

send the process data to the wireless handheld device.

3. The hybrid wireless network of paragraph 2, wherein the wireless handheld device is configured to associate at least a portion of the process data with a particular plant component based on an RFID device connected to the particular plant component.

4. The hybrid wireless network of paragraph 2, wherein the wireless handheld device is configured to send the process data to a distributed control system (DCS) or an asset management system, or both.

5. The hybrid wireless network of paragraph 2, wherein the wireless handheld device is configured to use the process data to perform an equipment health monitoring activity, an asset management activity, or a data mining activity, or any combinations thereof.

6. The hybrid wireless network of any of the preceding paragraphs, wherein the plurality of wireless transmitters are configured to function as wireless sensor network routers for the hybrid wireless network using the wireless sensor network protocol.

7. The hybrid wireless network of any of the preceding paragraphs, wherein the portion of the plurality of wireless transmitters that are enabled with the wireless sensor network protocol and the Wi-Fi protocol are configured to function as Wi-Fi routers for the hybrid wireless network using the Wi-Fi protocol.

8. The hybrid wireless network of any of the preceding paragraphs, wherein the wireless sensor network protocol includes WirelessHART.

9. The hybrid wireless network of any of the preceding paragraphs, wherein the wireless sensor network protocol includes ISA100.11a.

10. A method for communicating with a wireless transmitter via a hybrid wireless network, including:

establishing, at a wireless handheld device, a wireless sensor network connection with a plurality of wireless transmitters via a hybrid wireless network using a wireless sensor network protocol;

establishing, at the wireless handheld device, a Wi-Fi network connection with at least a portion of the plurality of wireless transmitters via the hybrid wireless network using a Wi-Fi protocol;

communicating, via the wireless handheld device, with any of the plurality of wireless transmitters via the wireless sensor network connection; and

communicating, via the wireless handheld device, with any of the portion of the plurality of wireless transmitters via the Wi-Fi network connection.

11. The method of paragraph 10, wherein communicating with any of the plurality of wireless transmitters via the wireless sensor network connection includes receiving, at the wireless handheld device, process data corresponding to any of a plurality of plant components from any of the plurality of wireless transmitters via the wireless sensor network connection.

12. The method of paragraph 11, including sending, via the wireless handheld device, the process data to a distributed control system (DCS) or an asset management system, or both.

13. The method of paragraph 11, including associating, via the wireless handheld device, at least a portion of the process data with a particular plant component based on an RFID device connected to the particular plant component.

14. The method of any of the paragraphs 10-13, wherein communicating with any of the portion of the plurality of wireless transmitters via the Wi-Fi network connection includes routing data from the wireless handheld device to another wireless device by using one of the portion of the plurality of wireless transmitters as a Wi-Fi router via the Wi-Fi network connection.

15. A plant, including:

a plurality of plant components;

a hybrid wireless network including a wireless sensor network that uses a wireless sensor network protocol and a Wi-Fi network that uses a Wi-Fi protocol;

a wireless handheld device that is enabled to use the wireless sensor network protocol and the Wi-Fi protocol; and

wireless transmitters, wherein a first portion of the wireless transmitters are only enabled to use the wireless sensor network protocol and a second portion of the wireless transmitters are enabled to use the wireless sensor network protocol and the Wi-Fi protocol, and wherein the wireless transmitters are configured to:

collect process data corresponding to any of the plurality of plant components; and

send the process data to the wireless handheld device.

16. The plant of paragraph 15, wherein the wireless handheld device is configured to associate at least a portion of the process data with a particular plant component based on an RFID device connected to the particular plant component.

17. The plant of either of the paragraphs 15 or 16, wherein the wireless handheld device is configured to send the process data to a distributed control system (DCS) or an asset management system, or both.

18. The plant of any of paragraphs 15-17, wherein the wireless handheld device is configured to use the process data to perform an equipment health monitoring activity, an asset management activity, or a data mining activity, or any combinations thereof.

19. The plant of any of paragraphs 15-18, wherein the first portion of wireless transmitters and the second portion of wireless transmitters are configured to function as wireless sensor network routers for the hybrid wireless network using the wireless sensor network protocol.

20. The plant of any of paragraphs 15-19, wherein the second portion of wireless transmitters are configured to function as Wi-Fi routers for the hybrid wireless network using the Wi-Fi protocol.

While the present techniques may be susceptible to various modifications and alternative forms, the embodiments discussed above have been shown only by way of example. However, it should again be understood that the techniques is not intended to be limited to the particular embodiments disclosed herein. Indeed, the present techniques include all alternatives, modifications, and equivalents falling within the true spirit and scope of the appended claims.

What is claimed is:

1. A hybrid wireless network for enabling communication between wireless devices, comprising a gateway that is enabled with a wireless sensor network protocol and a Wi-Fi protocol, wherein the hybrid sensor network enables communication between a wireless handheld device and a plurality of wireless transmitters using the wireless sensor network protocol and the Wi-Fi protocol, and wherein the wireless handheld device and at least a portion of the plurality of wireless transmitters are enabled with the wireless sensor network protocol and the Wi-Fi protocol.

2. The hybrid wireless network of claim 1, wherein the plurality of wireless transmitters are configured to:
collect process data corresponding to a plurality of plant components; and
send the process data to the wireless handheld device.

3. The hybrid wireless network of claim 2, wherein the wireless handheld device is configured to associate at least a portion of the process data with a particular plant component based on an RFID device connected to the particular plant component.

4. The hybrid wireless network of claim 2, wherein the wireless handheld device is configured to send the process data to a distributed control system (DCS) or an asset management system, or both.

5. The hybrid wireless network of claim 2, wherein the wireless handheld device is configured to use the process data to perform an equipment health monitoring activity, an asset management activity, or a data mining activity, or any combinations thereof.

6. The hybrid wireless network of claim 1, wherein the plurality of wireless transmitters are configured to function as wireless sensor network routers for the hybrid wireless network using the wireless sensor network protocol.

7. The hybrid wireless network of claim 1, wherein the portion of the plurality of wireless transmitters that are enabled with the wireless sensor network protocol and the Wi-Fi protocol are configured to function as Wi-Fi routers for the hybrid wireless network using the Wi-Fi protocol.

8. The hybrid wireless network of claim 1, wherein the wireless sensor network protocol comprises WirelessHART.

9. The hybrid wireless network of claim 1, wherein the wireless sensor network protocol comprises ISA100.11a.

10. A method for communicating with a wireless transmitter via a hybrid wireless network, comprising:
establishing, at a wireless handheld device, a wireless sensor network connection with a plurality of wireless transmitters via a hybrid wireless network using a wireless sensor network protocol;
establishing, at the wireless handheld device, a Wi-Fi network connection with at least a portion of the plurality of wireless transmitters via the hybrid wireless network using a Wi-Fi protocol;
communicating, via the wireless handheld device, with any of the plurality of wireless transmitters via the wireless sensor network connection; and
communicating, via the wireless handheld device, with any of the portion of the plurality of wireless transmitters via the Wi-Fi network connection.

11. The method of claim 10, wherein communicating with any of the plurality of wireless transmitters via the wireless sensor network connection comprises receiving, at the wireless handheld device, process data corresponding to any of a plurality of plant components from any of the plurality of wireless transmitters via the wireless sensor network connection.

12. The method of claim 11, comprising sending, via the wireless handheld device, the process data to a distributed control system (DCS) or an asset management system, or both.

13. The method of claim 11, comprising associating, via the wireless handheld device, at least a portion of the process data with a particular plant component based on an RFID device connected to the particular plant component.

14. The method of claim 10, wherein communicating with any of the portion of the plurality of wireless transmitters via the Wi-Fi network connection comprises routing data from the wireless handheld device to another wireless device by using one of the portion of the plurality of wireless transmitters as a Wi-Fi router via the Wi-Fi network connection.

15. A plant, comprising:
a plurality of plant components;
a hybrid wireless network comprising a wireless sensor network that uses a wireless sensor network protocol and a Wi-Fi network that uses a Wi-Fi protocol;
a wireless handheld device that is enabled to use the wireless sensor network protocol and the Wi-Fi protocol; and
wireless transmitters, wherein a first portion of the wireless transmitters are only enabled to use the wireless sensor network protocol and a second portion of the wireless transmitters are enabled to use the wireless sensor network protocol and the Wi-Fi protocol, and wherein the wireless transmitters are configured to:
collect process data corresponding to any of the plurality of plant components; and
send the process data to the wireless handheld device.

16. The plant of claim 15, wherein the wireless handheld device is configured to associate at least a portion of the process data with a particular plant component based on an RFID device connected to the particular plant component.

17. The plant of claim 15, wherein the wireless handheld device is configured to send the process data to a distributed control system (DCS) or an asset management system, or both.

18. The plant of claim 15, wherein the wireless handheld device is configured to use the process data to perform an equipment health monitoring activity, an asset management activity, or a data mining activity, or any combinations thereof.

19. The plant of claim 15, wherein the first portion of wireless transmitters and the second portion of wireless transmitters are configured to function as wireless sensor network routers for the hybrid wireless network using the wireless sensor network protocol.

20. The plant of claim 15, wherein the second portion of wireless transmitters are configured to function as Wi-Fi routers for the hybrid wireless network using the Wi-Fi protocol.
